(19) United States
(12) Patent Application Publication
(10) Pub. No.: US 2003/0191744 A1
(43) Pub. Date: Oct. 9, 2003

(54) Computer system for knowledge management

(76) Inventors: Torsten Derr, Dormagen (DE); Paul-Johannes Mayska, Krefeld (DE); Hakan Colakoglu, Duisburg (DE); Frank Schnieders, Leverkusen (DE); Thomas Kraft, Leverkusen (DE); Georg Heger, Krefeld (DE); Ralf Pakull, Pulheim (DE)

Correspondence Address: BAYER POLYMERS LLC, 100 BAYER ROAD, PITTSBURGH, PA, 15205, US

(21) Appl. No.: 10/407,597

(22) Filed: Apr. 4, 2003

(30) Foreign Application Priority Data
Apr. 9, 2002 (DE) 10215494.5

(51) Int. Cl. G06F 7/00

(52) U.S. Cl. 707/1

(57) ABSTRACT

The invention relates to a computer system for knowledge management with a first database means for storing documents and meta-information on documents, a second database means for storing user data, a means for accessing an external data source for loading external documents and storing external documents in the first database means, a first program means for the inputting a search request by an internal client computer, a second program means for adding a document to the first database means by the internal client computer, a third program means for inputting an evaluation for a document of the first database means by an internal client computer, a fourth program means for awarding and storing bonus points to the credit of a user as a function of user behavior.

### FIELD OF THE INVENTION

The present invention relates to a computer system for knowledge management and to a corresponding computer program product.

### BACKGROUND OF THE INVENTION

Various computer systems and methods for knowledge management are known. Knowledge management includes, among other things, the know-how management of an organization and also document management.

The significance of efficient knowledge management with the aid of information technologies for business success is generally known from the lectures “Wissen—der globale Wettbewerbsfaktor im Innovations—und Wissenszeitalter des dritten Jahrhundert”, Dr. Tom Sommerlatte, Vice President, Chairman Management Consulting Worldwide, Arthur D. Little International, Inc., Wiesbaden; “Knowledge Sharing bei der World Bank”, Stephen Denning, Program Director Knowledge Management, World Bank, Washington, D.C.; “Wissenbasierte Unternehmen—Ziele und Herausforderungen”, Prof. Dr. Claus Weyrich, Board Member, Siemens AG, Munich; “Wissen managen—Herausforderung an das Management des dritten Jahrhunderts”, Detlev Buchal, Board Member, Deutsche Telekom AG, Bonn; “Von der Informationsdrehscheibe zum Wissenmanagement”, James A. Champy, Chairman of Consulting, Perot Systems Corporation, Boston, “Wissensmanagement—Erfolgsfaktor für Finanzdienstleister”, Dr. Rolf-E. Breuer, Spokesman of the Board, Deutsche Bank AG, Frankfurt am Main; all these lectures were held at the Congress “Wissen an der Schwelle zum dritten Jahrtausend”, Sep. 1, 1999, Frankfurt am Main.

DE 199 55 481 A1 discloses a method for machine reproduction, integration and control of company processes, products and information technology structures. An integrated methodology is therein used to create a multi-dimensional and multi-stage model, comprising the overall architectural model for information systems and products and consisting of four hierarchical concept levels, which in each case holistically describe the methods of the procedure and the modeling. The model is designed as object-orientated; in other words, objects represent the individual processes and components. Moreover, a metamodel comprises the procedure models and a formal modeling language.

DE 692 26 673 T2 discloses a knowledge-base management system for an information inference device. The knowledge-based management system comprises a primary data memory for storing data, supplied by an external database via a primary data input segment, a change registering segment which, when a data batch is added to the primary data input segment or the data in this segment are changed, records information representing this change, a data converting segment which converts the primary data into secondary data, a knowledge-base segment which has a secondary data memory for storing secondary data and an inference rule memory for storing inference rules. The knowledge-based management system further contains a knowledge management segment for controlling conversion processing and an inference calculation segment for carrying out an inference in relation to the data in the knowledge-base segment.

DE 199 64 094 A1 teaches an artificial intelligence network for supporting innovations, wherein the neuronal network acts as computer-aided knowledge management and manages developments in an associative data structure.

DE 299 23 527 U1 and DE 199 23 622 A1 disclose a artificial intelligence network for computer-aided knowledge management, wherein the network consists of weighted elements related to one another, laid down dynamically by computer technology in the memory of the computer as an associative data structure, and assigning a significance content to the individual elements, the elements therein forming a Hilbert space.

An object of the present invention is to create an improved computer system for knowledge management and an improved computer program product for knowledge management.

### SUMMARY OF THE INVENTION

The present invention is directed to a computer system for knowledge management, which is standardized to the company and global. The present invention allows knowledge and know-how existing in a company to be reproduced in the computer system in a targeted way and to be made accessible to users in the company. Users can also add newly emerged knowledge to the computer system.

A computer system according to the invention additionally allows external data sources to be scanned in a targeted way and the information gained from external data sources to be integrated into the company knowledge management. It is therefore preferred if the computer system is designed in such a way that operation is without paper and with electronic documents only.

### BRIEF DESCRIPTION OF THE DRAWINGS

FIG. 1 illustrates a block diagram of an embodiment of a computer system according to the present invention.

FIG. 2 illustrates a flow diagram of an embodiment of a computer program product according to the present invention.

### DETAILED DESCRIPTION OF THE INVENTION

According to the present invention the computer system supports an internal company cycle including searching for knowledge, discovering knowledge, considering knowledge, evaluating knowledge and applying knowledge. The database for the search for knowledge, i.e. for appropriate files, therein forms the entire company knowledge and know-how and also contains thematically relevant information input from external data sources.

According to the present invention the computer system enables a user-specific so-called push service. In predetermined rotation a search is carried out for this purpose in the database for documents corresponding to a predetermined user-specific search profile. It is preferred that the number of “hits” brought to the attention of the user concerned is limited to a maximum number chosen by the user of, for example, ten or fifteen.

Further, according to the present invention each user has the opportunity of adding his own contents to the database. For example, a user carries out a search for documents according to a search profile. The user then processes these documents and from them and/or by means of further information constructs a new document. The user can add this new document to the database.

According to the present invention a document newly added to the database by a user must first be released in one or more steps before other users can access the document. For this purpose various roles of users can be defined, corresponding to the release steps. For example, normal users and users with the role of a releasing authority are defined.

According to the present invention each user has the opportunity of evaluating a document of the database. Evaluation can take place, for example, by a system of points.

Also according to the present invention bonus points are automatically awarded by the computer system to users of the system, this being as a function of user behavior. For example, a user can be given bonus points for setting up a new document, for inputting an evaluation of a document or else for carrying out a search and/or access to one of the documents. On achieving a certain minimum number of points the user can redeem his bonus points.

According to the present invention the computer system has a so-called data pump. This contains a list of external data sources, which are regularly scanned for new relevant information. The appropriate documents are imported into the computer system by the data pump from these external data sources and stored in the database. Preferably automatic keywording of these imported documents also takes place.

Also according to the present invention a hierarchical keyword index is used for keywording the documents and for the input of a search request. This is preferably constructed in such a way that synonyms for keywords and translations of keywords are also included in the index.

According to the present invention the computer system supports the so-called workflow for the release of a newly added document. The computer system generates a to-do list of documents to be checked for release for a user who has an appropriate role for release. The result of the checking is then noted for the document concerned in the database entry for the document.

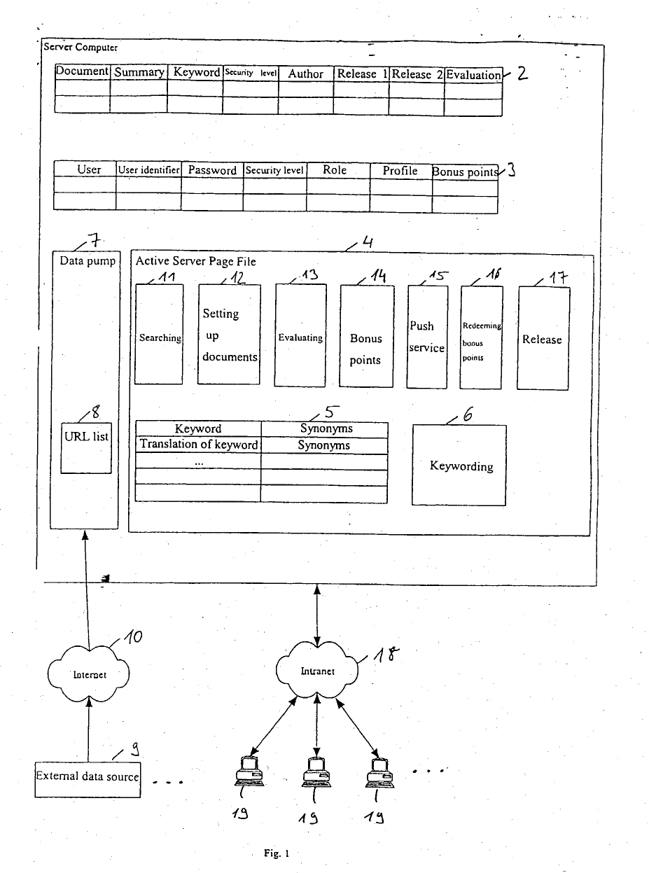

FIG. 1 shows a server computer 1 of an organization, such as a company. The server computer 1 contains a database 2 for storing documents. Database 2 serves to gather systematically the knowledge existing in the company and to reproduce it as recyclable. Database 2 further serves to add additional knowledge gained from external sources to the company knowledge.

Each data set in database 2 contains one document and meta-information belonging to the document. This meta-information can, for example, be a summary of the content of the document, one or more keywords, a security level, the author, one or more release stages and also one or more user evaluations. For example, as illustrated in FIG. 1, there are two release stages, “release 1” and “release 2.”

The server computer 1 further contains a database 3 for storing user data. A data set of database 3 contains, for example, the name of a user, his user identifier and password and also the security level, the role and the profile of the user and optionally the number of bonus points acquired by the user.

The server computer 1 further has a file 4, preferably designed as an Active Server Page (ASP) file. ASP is a Microsoft product, which makes available a server-side script environment and can be used for the design of interactive web pages and web applications. Detailed information on ASP can be called up from http://msdn.microsoft.com/library/default.asp. Other methods of implementation are provided, for example, by HTML, JAVA SCRIPT or PEARL.

The ASP file 4 contains a hierarchically constructed keyword index 5, which contains keywords grouped hierarchically according to categories and sub-categories. Business-relevant categories, such as products and product groups, product characteristics, themed projects, market sectors, production methods, partners and competitors, customers and countries, for example, are possible categories. There are also bibliographical categories, such as document types, preferably patents, presentations, visit reports, literature, etc.

The keyword index 5 preferably contains one or more synonyms for each keyword. It is further preferred to make documents researchable via the keyword index 5 in different languages with a monolingual search request. For this purpose the keyword index 5 contains for each keyword a translation of this keyword into one or more languages. One or more synonyms can be assigned to the translation of this keyword in the relevant language.

The ASP file 4 further has a script 6 for automatic keywording. Script 6 preferably serves for automatic keywording of external documents.

The data pump 7 of the server computer 1 is used for loading external documents. The data pump 7 contains a list 8 of external data sources 9, which can be accessed, for example, via the Internet 10 by the data pump 7. For example, the list 8 contains the addresses of external data sources containing information about competitors, such as, for example, competitors' press servers or competitors' home pages.

The data pump 7 preferably contacts each external data source, characterized by its address, i.e. its Uniform Resource Locator (URL) daily in order to search it for relevant information. The so-called scanning of these external data sources can be done in the same way as is known in the art for Internet Search Engines.

External documents identified as relevant and new are loaded by the data pump 7 into the server computer 1. By means of script 6 keywording of a newly loaded external document then takes place. The new document, together with the assigned keywords, is then stored in a new data set in database 2.

The ASP file 4 further contains a script 11, which makes available a search functionality. By means of script 11 an HTML document is generated which makes available an input mask for the input of a search request by a user.

The input mask is preferably constructed in such a way that, as well as the input field for the search request, a representation of the hierarchical keyword index is displayed. The user can then compile the search request by selecting one or more keywords from the hierarchical keyword index, wherein the individual selected keywords can be linked to one another by logical operators or suchlike. Selection of keywords from the hierarchical keyword index can be done via a graphical user interface, in other words, for example, by “clicking” keywords or by “drag and drop” of keywords from the hierarchical keyword index into the input field for the search request.

The ASP file 4 further contains a script 12 for setting up new documents by a user. Script 12 generates an HTML document with an input mask, which allows the user to add a new document. This is done, for example, in such a way that the user inputs the path via which the document concerned can be accessed, for example, on the user's hard drive. To input the path, graphical aids can be offered to the user, as is known from Microsoft Explorer.

The input mask generated by script 12 preferably contains data fields for the input of meta-information on the document to be newly added.

The ASP file 4 further contains a script 13 for evaluating documents stored in database 2. For this purpose script 13 generates an HTML document with an input mask for the input of an evaluation of one of the documents of database 2.

The ASP file 4 further contains a script 14 for managing bonus points. Script 14 records for this purpose the behavior of a particular user and assigns to this behavior particular bonus points, which are stored and accumulated in database 3. For example, script 14 awards bonus points for every log-in by a user on the ASP file 4 and also for use of functionalities of the ASP file 4, such as, for example, searching for documents, setting up new documents or evaluating documents (cf. script 11, 12, 13). A different number of bonus points can therein also be assigned to the use of different functionalities.

For example, a user receives one bonus point for logging in and one further bonus point for reading a document. A user receives twenty bonus points for evaluation and commentary on a contribution or short text and ten bonus points for the evaluation of contributions by third parties in order to give feedback. Fifty bonus points may be awarded by script 14 for a contribution newly set up by the user (cf. script 12) and twenty bonus points for a newly set up short text.

Script 14 further serves to generate an HTML document for displaying a user's bonus points. In this way a user can scan his bonus points currently stored in database 3.

The server computer 1 further has a script 15 for implementing a so-called push service. A push service of this kind provides the user with various functionalities.

The push service can be used for automatic carrying out of stored search requests pre-defined by the user. For example, the stored search request is then automatically carried out once a day, for example, and the corresponding “hits” transferred to the user concerned. The number of hits transferred to the user is preferably limited to a predetermined maximum number, such as ten or fifteen, for example, the most relevant documents being automatically selected by the push service (script 15).

Alternatively, the push service can also be used for communicating information of general interest or company news directed at every employee.

The push service can therein take place continually, daily, weekly or monthly or else at different time intervals.

The server computer 1 further contains a script 16 for redeeming bonus points. Script 16 serves to generate an HTML document, which enables a user to make a choice online with regard to redeeming his bonus points.

Users can for this choose particular goods; depending on the number of bonus points they have achieved, and “pay” for them with their bonus points. Alternatively to goods, users can also choose services or other facilities. The redeemed bonus points are debited from users from their bonus points account in database 3. Script 16 is preferably coupled to an inventory control system and/or a logistics system, which takes care of automatic transaction of the delivery of the products chosen by users.

The ASP file 4 further contains a script 17 for the release of a new document. If a new document is added to database 2 by a user (cf. script 12) this new document is at first not yet released.

For example, in this case the two data fields “release 1” and “release 2” have in each case the value logic zero. If a normal user starts a search request (cf. script 11) this user cannot access this not yet released document, even if the new document is part of the hit list of the search request.

Approval by a user who has the role of a first approving authority and also approval by a further user who has the role of a further approving authority is required for release. If, for example, a user with the role of “first approving authority” logs in to the system, this user's attention is drawn to a list of the new documents to be tested; corresponding output is generated by script 17.

The user can then input his releases into the system online, so, if applicable, they are noted in the data field “release 1” of database 2. For those newly added documents for which there is a “release 1” script 17 generates a list which is displayed to a user who has the role of a second approving authority as soon as this person logs on.

This user with the role of “second approving authority” can then in turn input his release online and this is noted in the data field “release 2” in database 2. The value logic one then appears in the data fields “release 1” and “release 2” as result in each case, so the new document is released and any normal user can access it. It is preferred with script 17 that it automatically controls the workflow for the release of documents newly added by users and integrates it into the overall system.

A further possibility of limiting access to particular documents of database 2 to a particular circle of users is offered by the data fields “security level” in database 2 and database 3. For example, the documents in database 2 can be classified by a security level of 1 to 5, wherein security level 5 concerns confidential documents and security level 1 public documents. On the other hand, every user has a security level assigned to him, so he can access documents up to a maximum of this security level. If a user has security level 3, for example, he can therefore access documents of security levels 1, 2 and 3, but not documents of security levels 4 and 5.

Documents added to database 2 from an external data source 9 via the data pump 7 normally have security level 1, as these are, public documents. The server computer 1 can be accessed by employees of the company via the Intranet 18. They have client computers 19 at their workstations for this purpose. To access the ASP file 4 the user of a client computer 19 first starts his web browser, such as, for example, Netscape Navigator or Microsoft Internet Explorer and inputs the URL of the ASP file 4. The user then logs in with his user identifier and password. Depending on the role of the user, he then automatically receives a search mask (cf. script 11) or a release mask (script 17)—the latter in the case of a user with the role of an approving authority.

In the case of a normal user, this person will typically input a search request via the search mask by selecting one or more keywords from the keyword index 5 and linking them logically to one another. A hit list is then displayed to the user as the result of the search request. Insofar as the security level of the user allows, the user can access these documents and further process them. The user can further input an evaluation for one or more of the documents of the hit list (script 13). The user can construct a new document on the basis of the information he has scanned. The user can then add this new document to database 2 (cf. script 12). For this use of the system the user is credited bonus points (cf. script 14). The user can redeem them as soon as he has reached a certain minimum number of points (cf. script 16).

Moreover, the user also has the opportunity of activating the push service (script 15) by depositing an appropriate profile and inputting the time intervals for transfer of the documents.

The system according to the present invention is outwardly open as regards the aggregation of documents, in other words in principle any external data sources 9 are accessed via the public internet in order to gather relevant knowledge. This is then keyworded according to the company-specific keyword index 5 by means of script 6 and stored in database 2. Thus far, therefore, external knowledge can be added to the company knowledge reflected in database 2.

On the other hand, internal company knowledge, arising, for example, from the evaluation of known information and documents, is also aggregated in database 2 in that an employee can deposit a document he has newly constructed in this database 2. To protect the company knowledge reproduced in this way it is preferred that reading access to database 2 is possible only via the Intranet 18 and also only by appropriately authorized users. The stored company knowledge is thereby protected from external access. Additionally firewalls and the like can be installed on the server computer 1 to protect the knowledge from external access.

According to the present invention it is possible to control the information to be reproduced in database 2 and to be researched by means of the keyword index 5.

The keyword index 5 preferably contains not just any keywords, but those, which have been chosen according to the specific company requirements and areas of interest. This also protects the system from misuse, as in this way only search requests, which are associated with the company's interest, can be formulated.

According to the present invention the workflow of the release of a document newly added by an employee forms an integral part of the system.

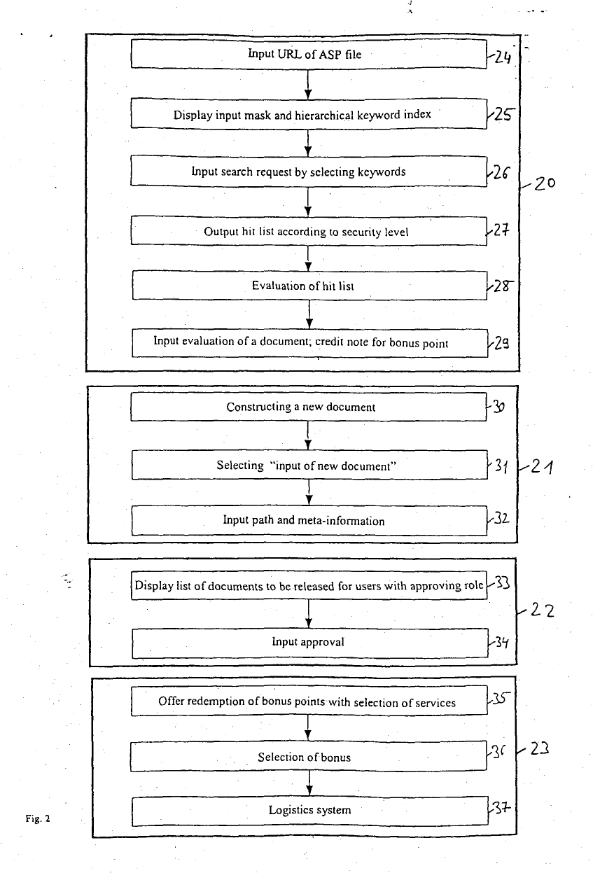

With reference to FIG. 2, a computer program product according to the present invention, as implemented in the ASP file 4 of FIG. 1.

The ASP file enables various processes 20, 21, 22 and 23, which in principle can be carried out in each case multiply and independently of one another.

One process 20 relates, for example, to one user session:

In step 24 the user inputs the URL of the ASP file into his browser. Thereupon in step 25 the user receives an input mask for inputting a search request and also a representation of the hierarchical keyword index. In step 26 the user inputs a search request by selecting keywords from the hierarchical keyword index, by linking the selected keywords to one another by means of logical operators.

In step 27 the user receives a hit list of the search in the system's document database. The user evaluates this hit list in step 28 by, for example, storing one or more documents of the hit list locally on his hard drive or printing out documents.

In step 29 the user inputs an evaluation of one or more of the documents and receives bonus points for his user behavior, which are credited in the user database in the bonus points account of this user.

Process 21 relates to adding a new document. For example, the user has in step 30 constructed a new document by evaluating the hit list (step 28 of process 20). The user then chooses the input function “input of a new document” in step 31.

The user then receives an appropriate input mask. There he inputs the path of the document on his hard drive and also meta-information relating to this document. This meta-information may concern, for example, keywords from the keyword index, a summary and a proposal for the security level. The new document is thereupon transferred together with the meta-information via the Intranet to the server computer and there stored in the document database. The meta-information is also deposited there.

Process 22 relates to the method of releasing newly added documents:

If a user with the role of approving authority logs in to the system, a list of documents to be tested for release is displayed to this user. Preferably these are only those documents which have been newly added by employees, but not documents which have been loaded from an external, public data source, as these are, of course, accessible to everyone in any case.

In step 34 this user then optionally inputs an approval. This is noted in the data field “release 1” or “release 2”, depending on whether the user has the role of a first or a second approving authority.

Process 23 relates to the redeeming of bonus points by a user.

After logging in, the user has the opportunity of choosing an input mask for redeeming bonus points. This is displayed to the user in step 35. Alternatively, this input mask is displayed automatically when the user has achieved a particular number of bonus points. This display screen mask indicates to the user the number of bonus points he has and also a choice of services for which the user can redeem his bonus points.

In step 36 the user selects a particular bonus. A logistics system for transaction of the delivery of the service is preferably thereby addressed in step 37.

List of reference numerals

| | |
|---|---|
| Server computer | 1 |
| Database | 2 |
| Database | 3 |
| File | 4 |
| Keyword index | 5 |
| Script | 6 |
| Data pump | 7 |
| List | 8 |
| Data source | 9 |
| Internet | 10 |
| Script | 11 |
| Script | 12 |
| Script | 13 |
| Script | 14 |
| Script | 15 |
| Script | 16 |
| Script | 17 |
| Intranet | 18 |
| Client computer | 19 |
| Process | 20 |
| Process | 21 |
| Process | 22 |
| Process | 23 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A computer system for knowledge management comprising
(a) a means for storing documents and meta-information on documents,
(b) a means for storing user data,
(c) a means for accessing an external data source,
(d) a means loading external documents and storing external documents in the means for storing documents,
(e) a means for inputting a search request by an internal client computer
(f) a means for adding a document to the means for storing documents by the internal client computer
(g) a means for inputting an evaluation for a document of the first means for storing documents by an internal client computer, and
(h) a means for awarding and storing bonus points to a credit of a user as a function of the users behavior.

2. The computer system according to claim 1, wherein the meta-information on a document comprises a summary, a tone or keyword(s), a security level of the document, an author, release information or an evaluation of the document by a user.

3. The computer system according to claim 1, wherein the user data comprises a name of the user, a user identifier, a password, a security level assigned to the user, role of the user, a user profile or bonus points assigned to the user.

4. The computer system according to claim 1, wherein the means for accessing an external data source is the Internet.

5. The computer system according to claim 1, further comprising a means for storing addresses of external data sources.

6. The computer system according to claim 1, further comprising a means for automatically generating meta-information on a document for the external document loaded from the external data source.

7. The computer system according to claim 1, further comprising a means for storing a hierarchical keyword index, wherein the means for the input of a search request select one or more keywords from the hierarchical keyword index.

8. The computer system according to claim 7, wherein the hierarchical keyword index has a keyword of a first language with one or more synonyms stored in the first language and for the keyword of the first language a translation of the keyword into a second language and; synonyms of the keyword in the second language are stored.

9. The computer system according to claim 7, further comprising a means for keywording documents to be stored in the means for storing documents with keywords from the hierarchical keyword index.

10. The computer system according claim 7, wherein the means for input of the search request are linked to the means for storing the hierarchical keyword index.

11. The computer system according to claim 10, wherein the means for inputting a search request select one or more keywords from the hierarchical keyword index.

12. The computer system according to claim 10, wherein the means for inputting a search request input a keyword in a first language as part of the search request, the search is automatically extended to synonyms of the keyword of the first language and the translation of the keyword into the second language and synonyms of the keyword in the second language.

13. The computer system according to claim 1, further comprising a means for controlling a workflow for the release of a document added to the means for storing documents.

14. The computer system according to claim 1, further comprising a means for offering bonus services for a user as a function of the number of bonus points achieved by the user, wherein the means for offering bonus services are connected to a logistics system for transacting the service.

15. A method for a computer supported knowledge management comprising:
(a) storing documents and meta-information of documents,
(b) storing user data,
(c) accessing an external data source,
(d) loading and storing the external documents,
(e) inputting a search request of the stored documents by an internal client computer,
(f) adding a new document to be stored by an internal client computer,
(g) inputting an evaluation of the new document to be stored by an internal client computer, and
(h) awarding and storing bonus points to credit of a user as a function of the users behavior.

16. The method according to claim 15, further comprising constructing a hierarchically keyword index and keywording the stored documents.

17. The method according to claim 16, wherein the external stored documents are automatically keyworded.

18. A computer program product for a computer system with a program means for knowledge management comprising:
(a) storing documents and meta-information of documents,
(b) storing user data,
(c) accessing an external data source,
(d) loading and storing the external documents,
(e) inputting a search request of the stored documents by an internal client computer,
(f) adding a new document to be stored by an internal client computer,
(g) inputting an evaluation of the new document to be stored by an internal client computer, and
(h) awarding and storing bonus points to credit of a user as a function of the users behavior.

19. The computer program product according to claim 18, further comprising automatically generating of meta-information on a document for an external document loaded from an external data source.

20. The computer program product according to claim 18, further comprising a controlling a workflow for release of a document to be stored.

21. The computer program product according to claim 18, further comprising offering bonus services for a user as a function of the number of bonus points achieved by the user.
